(19) United States
(12) Patent Application Publication
(10) Pub. No.: US 2011/0140002 A1
(43) Pub. Date: Jun. 16, 2011

(54) Photoluminescent Compositions, Methods of Manufacture and Novel Uses

(75) Inventors: Satish Agrawal, Concord, MA (US); Edward Kingsley, Stow, MA (US)

(73) Assignee: Performance Indicator, LLC, Lowell, MA (US)

(21) Appl. No.: 13/030,390

(22) Filed: Feb. 18, 2011

Related U.S. Application Data
(63) Continuation-in-part of application No. 11/808,266, filed on Jun. 7, 2007, now Pat. No. 7,910,022.
Application No. 11/808,266 is a continuation-in-part of application No. 12/874,441, filed on Sep. 2, 2010.
Application No. 12/874,441 is a continuation of application No. 11/793,376, filed on Feb. 29, 2008.
(60) Provisional application No. 60/844,647, filed on Sep. 15, 2006.
(60) Provisional application No. 60/637,535, filed on Dec. 20, 2004.

(51) Int. Cl. G01J 1/58; C09K 11/02

(52) U.S. Cl. 250/458.1; 252/301.36; 250/338.1; 250/372; 250/200

(57) ABSTRACT

A novel marking system is provided. The marking includes photoluminescent materials and provides for shifting of excitation energy. The marking provides flexibility for identification and tracking, both in stealth and non-stealth appearances.

### CROSS-REFERENCE TO RELATED APPLICATIONS

This application is filed under 35 U.S.C. §120, and claims the benefit of earlier filing dates associated with U.S. patent application Ser. No. 11/808,266, filed Jun. 7, 2007, entitled “Phosphorescent Compositions for Identification,” which in turn claims the benefit of U.S. Provisional Patent Application No. 60/844,647, filed Sep. 15, 2006, entitled “Phosphorescent Compositions and Methods for Identification Using the Same”; and U.S. patent application Ser. No. 12/874,441, filed Sep. 2, 2010, entitled “High-Intensity, Persistent Photoluminescent Formulations and Objects, and Methods for Creating the Same,” which in turn claims the benefit of U.S. patent application Ser. No. 11/793,376, filed Feb. 29, 2008, entitled “High-Intensity, Persistent Photoluminescent Formulations and Objects, and Methods for Creating the Same,” which is a National Stage Entry of PCT/US05/46039, filed Dec. 20, 2005, which also claims the benefit of U.S. Provisional Patent Application No. 60/637,535, filed Dec. 20, 2004, entitled, “Layered Envirochromic Materials, Applications and Methods of Preparation Thereof,” all of which are incorporated by reference herein in their entirety.

### BACKGROUND OF THE INVENTION

1. Field of the Invention

This invention relates to radiant energy, and more particularly, to compositions for luminophor irradiation, methods for making the compositions and applications making use of the compositions.

2. Description of the Related Art

Consumers have a continuing desire to receive added informational features and benefits from the products that they purchase. Appearance information may include indications of product safety, environmental information, shelf-life information, authentication and tamper information. Other features may provide benefits such as fashion accessories or offer fun and entertainment value. While consumers may be demanding, industrial users are even more so.

That is, while consumers generally judge products by personal perception (i.e., visual appearance, perceived efficacy), industrial users often have more rigorous standards. For example, instead of making visual assessments, industrial applications may employ remote sensing devices. When this is the case, appearance information needs to be presented in a uniform and reliable manner such that remote sensing equipment can accurately ascertain the information.

A number of products useful for providing appearance information, and for related purposes are known. For example, a variety of compositions are known that are photochromic, thermochromic, envirochromic or the like. Other compositions may be photoluminescent, such as phosphorescent and/or fluorescent. Unfortunately, many of the existing compositions and devices making use of the compositions, or combinations of the compositions, have not kept pace with the needs of consumers and industry.

Accordingly, there is a need for products that exhibit optical effects useful for providing information, as well as other features and benefits. Preferably, the products exhibit desired performance characteristics reliably and provide enhanced capabilities useful in a variety of environments.

### SUMMARY OF THE INVENTION

In one embodiment, the present invention provides for a method of fabricating a marking for object, the method including: selecting a plurality of photoluminescent materials for incorporation into a composition by correlating emission wavelengths exhibited by one of the materials with absorbance wavelengths of another one of the materials for each of the plurality, thus providing for a cascade of wavelengths from an excitation wavelength to an output wavelength for the marking upon completion of fabrication; incorporating the plurality of materials into the marking; and adapting the marking for association with the object.

In another embodiment, the present invention provides for a method of marking an object, the method including: selecting a marking that includes a composition that includes an effective amount of a plurality of photoluminescent materials, the materials including at least one phosphorescent material and, at least one fluorescent material; wherein each of the photoluminescent materials in the composition absorbs electromagnetic radiation of a first wavelength and emit electromagnetic radiation of a second wavelength; and wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking; and applying the marking to the object;

In a further embodiment, the present invention provides for a method for identifying an object, the method including: gazing at an detection area, and when a potential emission signature is detected; comparing the potential emission signature with an known emission signature, the known emission signature being associated with a marking that includes a composition that includes an effective amount of a plurality of photoluminescent materials, the materials including at least one phosphorescent material and, at least one fluorescent material; wherein each of the photoluminescent materials in the composition absorbs electromagnetic radiation of a first wavelength and emit electromagnetic radiation of a second wavelength; wherein the materials have been selected so that emission of a first one of the materials correlates with absorbance of another one of the materials in the plurality thus providing for a cascade of wavelengths beginning with a wavelength of electromagnetic radiation used for charging the marking to an output wavelength of the marking.

In an additional embodiment, the present invention provides for a marking for an object, the marking including: a composition that includes an effective amount of a plurality of photoluminescent materials, the materials including at least one phosphorescent material and, at least one fluorescent material; wherein each of the photoluminescent materials in the composition absorbs electromagnetic radiation of a first wavelength and emit electromagnetic radiation of a second wavelength; wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking; and a mount for associating the marking with the object.

In yet another embodiment, the present invention provides for a method of tracking an object, the method including: selecting an object including a marking, the marking including a plurality of photoluminescent materials; wherein each of the photoluminescent materials in the composition absorbs electromagnetic radiation of a first wavelength and emit electromagnetic radiation of a second wavelength; and wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking, the output wavelength being at least partially in the visible domain; energizing the marking; and observing the object.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a Jablonski Diagram illustrating aspects of atomic processes that occur between the absorption and emission of electromagnetic radiation. Step A illustrates absorption of a photon of electromagnetic radiation in which an electron in the absorbing material is excited from a ground state to an excited energy state. Depending on the excited state reached, the electron can degenerate by internal conversion (IC) or radiation-less internal conversion to the S1 state (which is the first vibrational excited state). The electron may then return to the ground state S₀ with a subsequent release of electromagnetic radiation in the form of fluorescence (F). Some materials will be excited into the excited state and their electrons will undergo Intersystem Crossing (ISC) and then reside in a T1 or T2 energy state. These states are meta-stable in that the electron can remain in the T1 or T2 states for comparatively long periods of time. When these electrons release energy by later returning to the ground state S₀, the electromagnetic radiation is released through phosphorescence (P). In some cases, the T1 or T2 state is very stable with little to no emission occurring. In this case a stimulating energy may be required to cause a release of electromagnetic radiation with the electron returning to the ground state S₀.

FIG. 2 illustrates a shift in emission spectra according to wavelength(s), as a result of incorporation of photoluminescent materials. Chart a) illustrates representative absorbance spectra, while Chart b) illustrates representative emission spectra and chart c) illustrates a representative net emission spectra resulting from the teachings herein. In this non-limiting example, excitation radiation is provided by an excitation source.

FIG. 3 illustrates an embodiment of an object (14) upon which a first photoluminescent layer (12) has been coated. The first photoluminescent layer (12) may include, for example, photoluminescent phosphorescent compositions or photoluminescent phosphorescent and photoluminescent fluorescent compositions, and further coated with a second photoluminescent layer (10) such second layer comprising selected photoluminescent fluorescent materials. It may be noted that in this embodiment, the second photoluminescent layer (10) may also serve as a protective layer, thus providing some degree of protection to the first photoluminescent layer. Collectively, in this embodiment, the first photoluminescent layer (12) and the second photoluminescent layer (10) provide a marking (20).

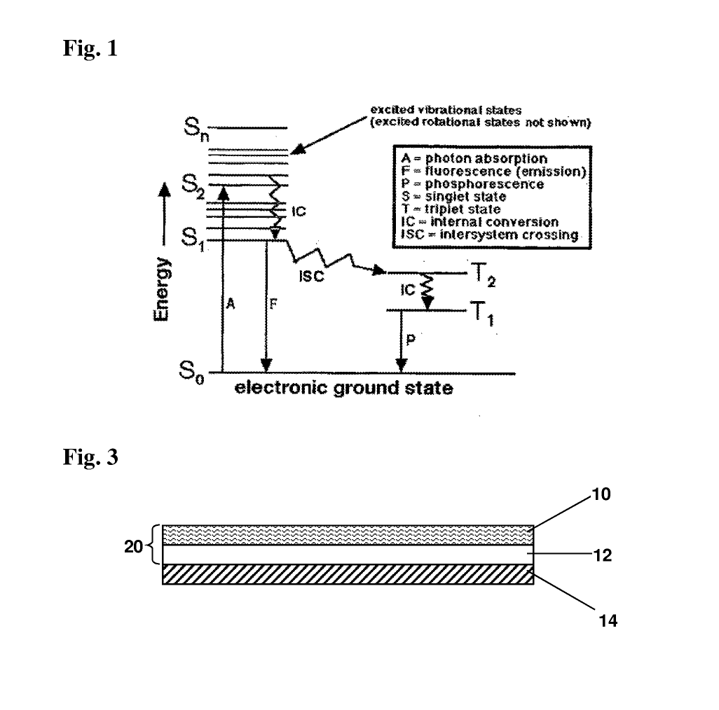

### DETAILED DESCRIPTION OF THE INVENTION

Disclosed herein are various products that provide or include energy shifting capabilities. The products, which may include compositions of matter, assemblies and apparatus making use of the compositions, methods of manufacture, and devices and apparatus taking advantage of the foregoing, as well as various combinations, are designed to receive electromagnetic radiation (i.e., energy) of various wavelengths, as well as other forms of energetic stimulation to shift the energy into a desired wavelength, or band of wavelengths. Generally, the products provide emissions that are in the visible domain or in the infrared domain. The products may provide emissions that are a combination of wavelengths, such as in the visible and the infrared domains.

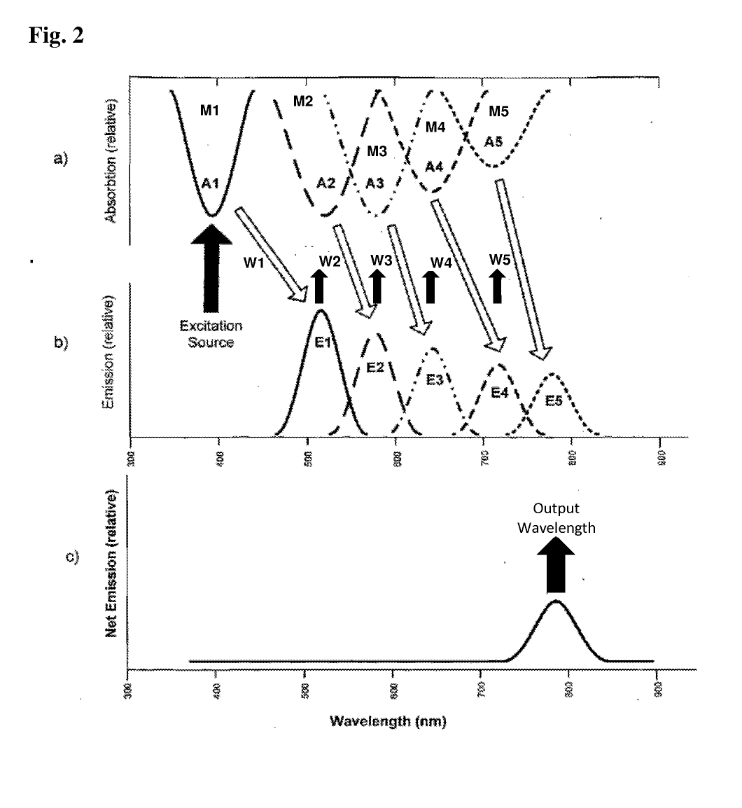

In FIG. 2, there is shown a non-limiting example of energy shifting. A combination of graphs is provided in FIG. 2. Collectively, these graphs illustrate energy shifting of incident photons. That is, the energy shifting device described (in part) in FIG. 2 is designed to receive excitation energy from (i.e., be pumped by) an excitation source and to provide an output wavelength that is shifted (i.e., separable) from the wavelength(s) of the excitation source.

As a matter of convention, the combinations discussed with regard to FIG. 2, may be collectively referred to as providing a “marking.” That is, the aspects of materials discussed with regard to FIG. 2 may be used to provide a variety of marking materials, discrete markings, techniques for marking, etc, . . . .

In the example of FIG. 2, five photoluminescent materials (M1-M5) are used in combination to shift the energy (i.e., photon wavelength) of incident light from an excitation source to an output wavelength. Each of the photoluminescent materials (M1-M5) exhibit a certain absorption peak (i.e., increased absorption of light at a certain wavelength, or within a band of wavelengths). Each of the photoluminescent materials (M1-M5) also exhibit a certain emission wavelength that is shifted (i.e., separable) from the wavelength(s) correlating to the respective absorption peak.

For purposes of illustration, the excitation radiation may generally be characterized as exhibiting an excitation wavelength (or band of wavelengths). A first photoluminescent material (M1) absorbs the excitation wavelength. When designed or fabricated, the photoluminescent material (M1) is selected to have an absorption peak (A1) (i.e., exhibit increased absorptivity) that generally correlates to the excitation wavelength. The first photoluminescent material (M1) responsively emits radiation that is shifted some wavelength (W1) from the absorption peak (A1) (and therefore, the excitation wavelength), thereby providing a first responsive emission wavelength (E1). The first responsive emission wavelength (E1) is separable from the excitation wavelength. A second photoluminescent material (M2) exhibits an absorption peak (A2) (i.e., exhibit increased absorptivity) that generally correlates to the first responsive emission wavelength (E1). The second photoluminescent material (M2) absorbs the first responsive emission wavelength (E1), and responsively emits radiation, that is shifted some wavelength (W2) from the absorption peak (A2), and therefore provides a second responsive emission wavelength (E2). Likewise, the second responsive emission wavelength (E2) is separable from the first responsive emission wavelength (E1). In the same way, a third photoluminescent material (M3) absorbs the second responsive emission wavelength (E2), thus producing a third responsive emission wavelength (E3). This process continues to the extent desired (and practicable) until an output wavelength is produced (as shown in Chart c)).

In this manner, a “cascade” of wavelengths is created, where the cascade provides for transformation of a charging or excitation wavelength to an output wavelength. The output wavelength may actually include a plurality of wavelengths. Accordingly, each marking may exhibit a particular output wavelength (primary emission) and may have at least one ancillary wavelength (secondary emission(s)) associated with the output wavelength.

The secondary wavelengths in the plurality of wavelengths may also have a characteristic intensity (i.e., relative intensity) that is particularly distinct when compared to the output wavelength of the marking. Accordingly, individuals making use of or providing the marking may recognize each marking has a characteristic “signature.” That is, each marking may exhibit a primary wavelength and at least one ancillary wavelength. When considering the signature, it is possible to further characterize or verify a marking by considering relative intensity of each emission wavelength, and any other optical property as a user may deem appropriate.

In the example shown in FIG. 2, the excitation wavelength (or group of wavelengths) is about 380 nm, while the output wavelength of photons from the device (i.e., composition of materials) is approximately 800 nm. Accordingly, it should be understood that the teachings herein provide for shifting the energy of incident photons over substantial ranges. Materials suited for achieving this effect are disclosed herein. Thus, by applying techniques disclosed herein, the energy of incident photons may be shifted from ultraviolet into the visible or infrared domains, as well as from the visible domain into the infrared domain.

The techniques disclosed herein may be applied in a variety of ways. For example, compositions may be created that include a homogeneous distribution of materials. In some embodiments, layered materials may be used for progressive shifting of wavelengths as the light travels through the layers. Materials may include at least one of fluorescent and phosphorescent materials. In some further embodiments, optical filtration may be used, such as in an embodiment involving layered materials. In these embodiments, filtration may be desired, for example, to ensure the output wavelength(s) do not include the initial excitation wavelengths. In these embodiments, optical filtration may be desired, for example, to eliminate some or all of the unwanted emissions (i.e. initial excitation wavelengths, emissions from other photoluminescent materials within the cascade). Optical filtration may be desired to modulate the output wavelength and waveshape (i.e. peak width at ½ height) of the cascaded emission.

The products disclosed herein that provide for cascading of wavelengths may be used advantageously in combination with other products. For example, energy shifting products may be used to enhance the remote detection, identification and tracking of other objects.

Remote detection may be accomplished by unaided observation (i.e., by visual spotting) and by use of detection equipment. Detection equipment may be arranged to observe a surrounding environment for selected wavelengths, or groups of wavelengths. The selected wavelengths may be of any wavelength deemed suitable by a system user, designer, owner, operator, etc, . . . . Non-limiting examples of detection equipment include a charge-coupled device (CCD), a complementary metal oxide semiconductor (CMOS) device and other equivalent devices, together with appropriate equipment (such as a processor, data storage, algorithms including machine executable code stored on machine executable media). Exemplary off-the-shelf detection equipment include commercially available cameras, including still and video cameras, together with optical filters as may be appropriate for enhancing detection.

Some embodiments of detection equipment may be well suited for certain embodiments, such as detection of markings provided in a fixed geometry, proximate to the detection equipment. Other detection equipment may include specially adapted sensors, such as a sensor tailored to provide sensitivity at a desired band of wavelengths, such as the output wavelengths of the marking. Non-limiting examples of sensors include particular adaptations of silicon sensors as well as Gallium Arsenide sensors. Adaptations may include optical filtration and the like as deemed appropriate by a user or manufacturer.

Regardless of the manner of detection chosen, detection calls for gazing at a detection area, whether only momentarily, or for extended durations. When a candidate wavelength or group of wavelengths is identified, additional steps for identification and authentication may be taken.

Remote identification may be accomplished by use of detection information and subsequent interpretation of associated data. For example, users may read lettering or code and instantly understand a given message. In other instances, identification equipment (such as a processor, data storage, algorithms including machine executable code stored on machine executable media) may compare detection information with stored information. For example, complex codes (such as a bar code) may be interpreted by reference to a database of complex codes. Output from the identification equipment is then provided to a user. In this latter example, where identification equipment is used, users may be provided with substantial information by capitalizing on data storage and/or code design.

Further, tracking may be accomplished by use of known techniques. For example, a camera may be used where directional migration of a data signal is followed by servos and other similar equipment. Tracking equipment may also take advantage of various devices (such as a processor, data storage, algorithms including machine executable code stored on machine executable media), to estimate speed, direction, trajectory and any other tracking parameter as may be associated with an object.

In short, remote detection, remote identification and tracking may take advantage of a variety of technologies that are presently known or as may later be devised. As many examples are known to those skilled in the art, these technologies are generally not discussed further herein.

In order to provide some context for the teachings herein, some definitions are now provided.

As used herein, a “luminescent” material is a material capable of emitting electromagnetic radiation after being excited into an excited state.

As used herein, a “photoluminescent composition” is defined as an admixture of materials which is capable of emitting electromagnetic radiation from electronically-excited states when excited or charged or activated by electromagnetic radiation.

As used herein, a “fluorescent” material is a material that has the ability to be excited by electromagnetic radiation into an excited state and which releases energy in the form of electromagnetic radiation rapidly after excitation. Emissions from fluorescent materials do not exhibit any perceptible persistence. That is, emission essentially ceases after an excitation source is removed. The released energy may be in the form of UV, visible or infrared radiation.

As used herein, “electromagnetic radiation” generally includes ultraviolet (UV), visible (VIS) and infrared (IR) wavelengths. Each of these categories may be further broken down into sub-classes (such as near IR). Generally, and as only as a matter of convention for this discussion, UV includes wavelengths shorter than that of visible light, but longer than X-rays, in the range about 10 nm to about 400 nm, and energies from 3 eV to 124 eV. The visible spectrum is the portion of the electromagnetic spectrum that is visible to (can be detected by) the human eye. Electromagnetic radiation in this range of wavelengths is called “visible light” or simply “light.” A typical human eye will respond to wavelengths from about 400 to 700 nm. Infrared (IR) light is electromagnetic radiation with a wavelength longer than that of visible light, starting from the nominal edge of visible red light at about 700 nm, and extending conventionally to about 300,000 nm. These wavelengths include most of the thermal radiation emitted by objects near room temperature.

As used herein, the terms “activating radiation,” “exciting radiation” and the like refer to incident radiation exhibiting one wavelength (or a group of wavelengths), where the one wavelength is shifted to another wavelength (or group of wavelengths). Further, in some embodiments, additional mechanisms for imparting energy (i.e., stimulating energy) may cause or enhance an output wavelength.

Consider for example, that color change can occur from a multiplicity of triggers. In this regard, the word “chromic,” as used herein, may signify a color change (i.e., a change in wavelength or energy), and may involve a change in reflection, absorption, or scattering of electromagnetic radiation. Thus, for example: “photochromism” signifies a change triggered by electromagnetic radiation, and may be exhibited by a “photochromic material”; “thermochromism” signifies a change triggered by change in temperature, and may be exhibited by a “thermochromic material”; “electrochromism” signifies a change occurring due to gain or loss of electrons, and may be exhibited by an “electrochromic material”; “solvatochromism” signifies a change resulting from change in solvent polarity, and may be exhibited by a “solvatochromic material”; “halochromism” signifies a change caused by a change in pH, and may be exhibited by a “halochromic material”; “ionochromism” signifies a change caused by ions, and may be exhibited by a “ionochromic material”; “tribochromism” signifies a change caused by change in mechanical friction, and may be exhibited by a “tribochromic material”; and “piezochromism” signifies a change induced by application of mechanical pressure, and may be exhibited by a “piezochromic material.”

As used herein, a “phosphorescent” material is a material that has the ability to be excited by electromagnetic radiation into an excited state, but the stored energy is released gradually. Emissions from phosphorescent materials have persistence, that is, emissions from such materials are perceived to be sustained for some period after the excitation is removed. Persistence can last for seconds, minutes or even hours after the excitation source is removed. The released energy may be in the form of UV, visible or infrared radiation.

“Luminescence,” “phosphorescence” and “fluorescence” are terms used to describe release of electromagnetic radiation from a luminescent, phosphorescent or fluorescent material, respectively.

As used herein “Luminous Intensity” is a measure of the wavelength-weighted power emitted by a light source in a particular direction per unit solid angle. Generally, luminous intensity based on the luminosity function, a standardized model of the sensitivity of the human eye. The SI unit of luminous intensity is the candela (cd), an SI base unit.

As used herein “emission intensity” is defined as a measure of the photoluminescent emissions from a photoluminescent object, such measurement being made with any device capable of measuring the emission strength either photometrically or radiometrically, such emissions being either visible or infrared or both.

As used herein “persistence” is defined as the time it takes, after discontinuing irradiation, for photoluminescent emissions emanating from a photoluminescent object to decrease to the threshold of detectability with a suitable detection apparatus (which may include human perception). As used herein “high persistence” is defined as persistence that exceeds about five hours.

As used herein, an “emission signature” refers to the specific emission spectrum of the photoluminescent composition (i.e., marking) as a result of activation, such emission exhibiting a wavelength and an amplitude or intensity.

As used herein “radiation incident upon the photoluminescent composition” and similar terminology refers to activating or charging electromagnetic radiation wherein at least some of the incident electromagnetic radiation will excite one or more of the photoluminescent materials.

As used herein, “Stokes shift” refers to a difference in wavelengths between the excitation or activation wavelength and the emission wavelength of photoluminescent materials.

As used herein, a “liquid carrier medium” is a liquid that acts as a carrier for materials distributed in a solid state and/or dissolved therein.

As used herein, a “stabilizing additive” is a material added to a composition so as to uniformly distribute materials present therein. The materials in the composition requiring distribution include, for example, particulates. Stabilization may be provided to prevent agglomeration, and/or prevent settling of solid material in the liquid carrier medium. Such stabilizing additives generally include dispersants, and/or rheology modifiers.

As used herein, “rheology modifiers” are those substances which generally can modify viscosity in liquid dispersion compositions. That is, a rheology modifier may be used to build viscosity in a composition containing particulate matter distributed in a liquid carrier, thereby retarding settling of such particulate materials, while at the same time significantly lowering viscosity upon application of shear, to enhance smooth applicability of such compositions onto objects.

As used herein, “dispersing agents” are those substances which are used to maintain dispersed particles in suspension in a composition in order to retard settling and agglomeration.

As used herein, “photostabilizer” refers to a material designed to retard deterioration, degradation or undesirable changes in compositional and/or visual properties as a result of exposure to electromagnetic radiation.

As used herein, a “layer” is a thickness of material that may be characterized by at least one property. A layer may be homogeneous or heterogeneous in composition. One example of a layer is a film derived from a substantially dried polymeric resin. A layer may also result from extrusion, molding, casting or other forms of fabrication. A layer may be separated from a substrate, and be an independent structure. A layer may include other materials, such as glass beads, placed between other layers. Accordingly, a layer is not necessarily an independently cohesive structure. In some embodiments, a layer a film resulting from a composition containing at least one film-forming polymeric resin. When dry, in this embodiment, the layer may be characterized by the residual liquid carrier medium being in the range of 0-5 weight % of the total weight of the layer. A layer may also be referred to as a “film” and by other similar terms.

As used herein “clandestine or stealth identification” refers to the act of identifying or detecting an object designed to exhibit limited detectability. For example, where emissions from associated photoluminescent markings used for such identification or detection are ordinarily not visible to a human observer either during daytime or nighttime and wherein the emissions from such photoluminescent markings require specific detection equipment for observation for the purpose of identification or detection, and further wherein, activation or charging is not required during detection.

As used herein “stealth marking” refers to a marking that has been designed to have limited detectability to those not trained or equipped to observe the marking.

As used herein the terminology “spatially decoupled and “temporally decoupled” refers to capability for detection after the activation has ceased (temporally) as well as detection can occur away from the object and/or its activation source (spatially).

As used herein “CAS #” is a unique numerical identifier assigned to every chemical compound, polymer, biological sequences, mixtures and alloys registered in the Chemical Abstracts Service (CAS), a division of the American Chemical Society.

Unless otherwise noted, percentages used herein are expressed as weight percent. Further aspects of terminology used herein may be defined elsewhere in this disclosure.

In general, the selected photoluminescent materials absorb incident electromagnetic radiation, for example, ultraviolet and/or visible portions of the electromagnetic spectrum, and an electron is excited from a ground state, S₀, into an excited state. The excited state electron of a phosphorescent material undergoes intersystem crossing (ISC) wherein the electron is trapped in the excited state and only slowly returns to the ground state with a subsequent emission of electromagnetic radiation, for example, in the visible region of the electromagnetic spectrum. The time for emission to occur from the excited state of phosphorescent materials can be on the order of 10⁻³ seconds to hours and even days. In this manner, emission radiation from excited phosphorescent materials can continue long after the incident radiation has ceased.

The energy of the emission radiation from a photoluminescent material is generally of lower energy than the energy of the incident activating radiation. This difference in energy is called a “Stokes shift.”

In some embodiments, suitable phosphorescent materials include the well-known metal sulfide phosphors such as ZnCdS:Cu:Al, ZnCdS:Ag:Al, ZnS:Ag:Al, ZnS:Cu:Al as described in U.S. Pat. No. 3,595,804 and metal sulfides that are co-activated with rare earth elements such as those describe in U.S. Pat. No. 3,957,678. Phosphors that are higher in luminous intensity and longer in luminous persistence than the metal sulfide pigments that are suitable for the present invention include compositions comprising a host material that is generally an alkaline earth aluminate, or an alkaline earth silicate. The host materials generally include Europium as an activator and often include one or more co-activators such as elements of the Lanthanide series (e.g. lanthanum, cerium, praseodymium, neodymium, samarium, gadolinium, terbium, dysprosium, holmium, erbium, thulium, ytterbium, and lutetium), tin, manganese, yttrium, or bismuth. These patents (U.S. Pat. Nos. 3,595,804 and 3,957,678) are incorporated by reference herein in their entirety.

High emission intensity and persistence phosphorescent materials can be alkaline earth aluminate oxides having the formula MO.mAl₂O₃:Eu²⁺, R³⁺ wherein m is a number ranging from about 1.6 to about 2.2, M is an alkaline earth metal (strontium, calcium or barium), Eu is an activator, and R is one or more trivalent rare earth materials of the lanthanide series (e.g. lanthanum, cerium, praseodymium, neodymium, samarium, gadolinium, terbium, dysprosium, holmium, erbium, thulium, ytterbium, lutetium), yttrium or bismuth co-activators. Examples of such phosphors are described in U.S. Pat. No. 6,117,362. This patent is incorporated by reference herein in its entirety.

High emission intensity and persistence phosphors can also be alkaline earth aluminate oxides having the formula MₖAl₂O₄:2xEu²⁺, 2yR³⁺ wherein k=1-2x-2y, x is a number ranging from about 0.0001 to about 0.05, y is a number ranging from about x to 3x, M is an alkaline earth metal (strontium, calcium or barium), Eu²⁺ is an activator, and R is one or more trivalent rare earth materials (e.g. lanthanum, cerium, praseodymium, neodymium, samarium, gadolinium, terbium, dysprosium, holmium, erbium, thulium, ytterbium, lutetium), yttrium or bismuth co-activators. Examples of such phosphors are described in U.S. Pat. No. 6,267,911B1. This patent is incorporated by reference herein in its entirety.

Phosphors that can be used in this invention also include those in which a portion of the Al³⁺ in the host matrix is replaced with divalent ions such as Mg²⁺ or Zn²⁺ and those in which the alkaline earth metal ion (M²⁺) is replaced with a monovalent alkali metal ion such as Li⁺, Na⁺K⁺, Cs+ or Rb⁺. Examples of such phosphors are described in U.S. Pat. No. 6,117,362 and U.S. Pat. No. 6,267,911B1. These patents (U.S. Pat. Nos. 6,117,362 and 6,267,911) are incorporated by reference herein in their entirety.

High intensity and high persistence silicates can be used in this invention such as has been reported in U.S. Pat. No. 5,839,718, such as (Sr, M¹)O—(Mg, M²)O—(Si,Ge)O₂:Eu:Ln wherein M is beryllium, zinc or cadmium and Ln is chosen from the group consisting of the rare earth materials, Group 3A elements, scandium, titanium, vanadium, chromium, manganese, yttrium, zirconium, niobium, molybdenum, hafnium, tantalum, tungsten, indium, thallium, phosphorous, arsenic, antimony, bismuth, tin, and lead. Particularly useful are dysprosium, neodymium, thulium, tin, indium, and bismuth. This patent is incorporated by reference herein in its entirety.

Other phosphorescent materials suitable for this invention are alkaline earth aluminates of the formula MO.Al₂O₃.B₂O₃:R wherein M is a combination of more than one alkaline earth metal (strontium, calcium or barium or combinations thereof) and R is a combination of Eu²⁺ activator, and at least one trivalent rare earth material co-activator, (e.g. lanthanum, cerium, praseodymium, neodymium, samarium, gadolinium, terbium, dysprosium, holmium, erbium, thulium, ytterbium, lutetium), bismuth or manganese. Examples of such phosphors can be found in U.S. Pat. No. 5,885,483. Alkaline earth aluminates of the type MAl₂O₄, which are described in U.S. Pat. No. 5,424,006, are also suitable for practice with the teachings herein. These patents (U.S. Pat. Nos. 5,885,483 and 5,424,006) are incorporated by reference herein in their entirety.

Phosphors that can be used in this invention also include phosphors comprising a donor system and an acceptor system such as described in U.S. Pat. No. 6,953,536 B2. This patent is incorporated by reference herein in its entirety.

Phosphorescent materials described above generally absorb in the UV or near UV/Visible regions of the electromagnetic spectrum with subsequent emissions from 390-700 nm.

As can be appreciated, many other phosphors are useful to the present invention. Such useful phosphors are described in Yen and Weber, Inorganic phosphors: compositions, preparation and optical properties, CRC Press, 2004.

In general, the selected photoluminescent fluorescent materials absorb incident activating electromagnetic radiation, for example, ultraviolet, visible and/or infrared portions of the electromagnetic spectrum and an electron is excited from a ground state into an excited state. In the case of such photoluminescent fluorescent materials the electron returns rapidly to the ground state with subsequent release of electromagnetic radiation, for example, ultraviolet, visible and/or infrared radiation. The time for emission to occur from the excited state in photoluminescent fluorescent materials can be on the order of 10⁻⁸ seconds. Continued emission from photoluminescent fluorescent materials ceases when the activating energy ceases. The energy of the emission is generally lower than the energy of the incident activating radiation.

Selected photoluminescent fluorescent materials useful in the current invention include photoluminescent fluorescent materials that absorb in the visible and/or infrared and emit in the visible and/or infrared. For example, photoluminescent fluorescent materials that absorb in the visible and emit in the visible include, for example, coumarins such as coumarin 4, coumarin 6, and coumarin 337; rhodamines such as rhodamine 6G, rhodamine B, rhodamine 101, rhodamine 19, rhodamine 110, and sulfarhodamine B; phenoxazones including Nile red and cresyl violet; styryls; carbostyryls; stilbenes; and fluoresceins. Examples of photoluminescent fluorescent materials that absorb in the visible region of the electromagnetic spectrum and emit in the far visible and infrared regions include, for example, Nile Blue, IR 140 (CAS #53655-17-7), IR 125 (CAS #3599-32-4), and DTTCI (CAS #3071-70-3). Below in Table 1 are the absorption and emission characteristics of some of the photoluminescent fluorescent materials suitable for practicing the teachings herein.

TABLE 1

| | | Max. | Max. |
|---|---|---|---|
| Fluorescent | | Absorbance | Emission |
| Material | CAS # | (nm) | (nm) |
| Coumarin 6 | 38215-35-0 | 458 | 505 |
| Rhodamine 110 | 13558-31-1 | 510 | 535 |
| Rhodamine 19P | 62669-66-3 | 528 | 565 |
| Rhodamine 6G | 989-38-8 | 530 | 556 |
| Nile red | 7385-67-3 | 550 | 650 |
| Nile blue | 53340-16-2 | 633 | 672 |
| IR 676 | 56289-64-6 | 676 | 720 |

IR-676 is 1,1′,3,3,3′,3′-Hexamethy1-4,5,4′,5′-dibenzoindodicarbocyanine

When photoluminescent phosphorescent materials are admixed with selected photoluminescent fluorescent materials, the emission of the photoluminescent phosphorescent materials can be absorbed by the photoluminescent fluorescent materials with subsequent emission which exhibit a downward Stokes shift to an energy level that is lower than the energy used to excite the photoluminescent phosphor. The emission energy from the photoluminescent fluorescent material can be absorbed by a second photoluminescent fluorescent material selected for its ability to absorb such radiation. The second photoluminescent fluorescent material will exhibit a downward Stokes shift to an energy level that is lower than the energy emitted from the first photoluminescent fluorescent material. Additional photoluminescent fluorescent materials can be chosen to further exhibit Stokes shifts until a selected emission is achieved. The selected emission can be chosen to be partially or fully in the infrared regions of the electromagnetic spectrum. Generally, a Stokes shift for a single photoluminescent phosphorescent or photoluminescent fluorescent material ranges from about 20 to about 100 nm. In order to produce longer Stokes shifts, multiple photoluminescent fluorescent materials can be used to produce a cascading Stokes shift. A cascading Stokes shift is produced by successive absorptions of the emission of one of the photoluminescent materials by another of the photoluminescent fluorescent materials and re-emission at a longer wavelength. When multiple materials are used to provide the cascading effect, Stokes shifts significantly in excess of 50 nm can be created.

The quantum efficiency of compositions comprising photoluminescent phosphorescent and/or photoluminescent fluorescent materials will be dependent on a number of factors, such as degree of overlap between the emission spectrum of one of the photoluminescent materials with the absorption spectrum of another of the photoluminescent materials and the degree to which the photoluminescent fluorescent materials are molecularly dispersed in the polymer comprising the binding matrix. In order for the photoluminescent fluorescent materials to be molecularly dispersed in the polymer or exist as a solid state solution in the chosen polymer or polymers, it is essential for the photoluminescent fluorescent materials to be in solution in the liquid carrier medium and be compatible with the chosen polymers.

Selected admixing of photoluminescent phosphorescent materials with photoluminescent fluorescent materials will result in compositions that can be charged or activated by incident electromagnetic energy, for example, by ultraviolet, visible, or combinations thereof, and emit partially or fully in the infrared. Since the activated photoluminescent phosphorescent material will continue to emit radiation long after the activating radiation has been removed, the photoluminescent composition will continue to emit radiation partially or fully in the infrared region of the electromagnetic spectrum.

It can readily be seen that activation of the inventive compositions and detection of their subsequent emission can occur at separate times and at separate places. Thus, the compositions can be applied to an object and charged with electromagnetic radiation. The radiation can be shut off and the object can be moved to a different place while the emissions continue to occur enabling detection to occur long after activation has ceased.

Selected photoluminescent fluorescent materials can additionally be incorporated into the photoluminescent compositions containing the above described photoluminescent phosphorescent and photoluminescent fluorescent materials to optimally couple the excitation source and the absorbance spectrum of a selected photoluminescent material that is to be initially activated from an external electromagnetic radiation source.

The photoluminescent fluorescent materials of the current invention that exhibit this property can be admixed into the photoluminescent composition containing the phosphorescent materials or they can reside in a coating either above or below such photoluminescent composition, or both.

It has also been found that photoluminescent compositions comprising an effective amount of one or more photoluminescent phosphorescent materials, one or more photoluminescent fluorescent materials, one or more liquid carriers, one or more polymeric binders, one or more photostabilizers, one or more rheology modifiers, and one or more dispersing agents can be selected to give an emission signature which is totally or partially in the visible and/or infrared region of the electromagnetic spectrum. It has been further found that with selection of certain alkaline earth phosphorescent materials, referred to above, the emission signature can have high intensity and persistence.

For high performance of luminescent materials (that is, high intensity and persistence), specific photoluminescent materials and mixtures of such materials may be adapted for use in given or varying conditions. For example, excitation conditions and/or environmental considerations may be considered when designing a marking. Water-resistant compositions suitable for protecting the photoluminescent phosphorescent particles and compositions that minimize photolytic degradation may be used. Beyond the selection of the photoluminescent phosphorescent materials and/or any additional photoluminescent fluorescent materials used to enhance their performance, it should be noted that the emission intensity and/or persistence from a photoluminescent composition may be affected by both the way in which the photoluminescent phosphorescent materials are distributed and the additives used, as well as the manner in which the particular composition is applied.

The improper selection and use of the composition materials, such as binders, dispersing agents, wetting agents, rheology modifiers, photostabilizers, and the like can diminish the emission intensity emanating from the composition. This can occur, for example, due to agglomeration or settling of photoluminescent phosphorescent particles, either during handling of the formulated materials or after application of the formulated materials. The reduction in emission intensity and/or persistence can result from incomplete excitations and/or scattering of emitted radiation. The scattering of photoluminescent emissions can be either due to agglomeration of photoluminescent phosphorescent material or as a consequence of electromagnetic radiation scattering by one or more of the additives selected to stabilize the photoluminescent phosphorescent pigment dispersion. The net result will be lower emission intensity and persistence.

The use of colorants in the form of pigments that are absorptive of visible electromagnetic radiation, in order to impart daylight color to photoluminescent compositions, even when such pigments are not absorptive of photoluminescent emissions, can result in degradation of photoluminescent intensity and persistence by virtue of either scattering of photoluminescent emissions or by inadequate charging of photoluminescent phosphorescent materials. Hence, for attaining a high degree of emission intensity, use of absorptive pigments may be avoided. It should be noted, however, that creation of stealth markings can be aided by the selective use of absorptive pigments designed to adjust the daylight color of the markings so that a photoluminescent marking will blend in with the surrounding areas. By keeping the amount of pigment used low, one can reduce a negative impact on the emission intensity and persistence of the emission signature.

As mentioned earlier, for stealth identification, the emission is not ordinarily observable by a human observer. It should be noted, however, that there is a wide range of capability in humans for the detection of visible radiation. Hence, for highly sensitive applications, wherein it is desirable that there be no circumstance wherein even a human observer with acute vision can perceive emissions, even after long adaptation to nighttime conditions, and standing very close to the object with the photoluminescent marking, one can ensure a high degree of stealth detection by incorporating a low level of a visible light absorptive pigment, either in the photoluminescent markings or in a layer above the photoluminescent marking. This may be particularly useful where the marking relies on an emission signature that lies predominantly in the infrared domain.

In some embodiments, it is preferred to select only those polymeric binder resins for the photoluminescent materials that do not absorb electromagnetic radiation within the excitation spectrum of the chosen photoluminescent material and that are also compatible with the selected photoluminescent materials. This limits inhibition of the excitation of the photoluminescent materials. In these embodiments, it may also be desirable that the chosen polymeric materials have minimal impact on the emission intensity. That is, the polymeric materials should not exhibit any significant quenching of the photoluminescence. Binder resins suitable for these embodiments include acrylates, for example NeoCryl® B-818, NeoCryl® B-735, NeoCryl® B-813, and combinations thereof, all of which are solvent soluble acrylic resins available from DSM NeoResins®, polyvinyl chlorides, polyurethanes, polycarbonates, and polyesters, and combinations thereof.

The liquid carrier can be, for example, any solvent which does not adversely impact the photoluminescent materials and which allows for the solubility of the photoluminescent fluorescent materials selected for the photoluminescent composition. In selecting the liquid carrier, for cases wherein the polymer is soluble in the liquid carrier, the polymeric solution should be clear and should not exhibit any haze, otherwise, emission intensity transmission will be adversely impacted. In general, highly polar solvents will increase the likelihood of emission quenching, and hence should, in general, be avoided. Suitable liquid carriers include glycols, glycol ethers, glycol acetates, ketones, hydrocarbons such as toluene and xylene.

Photostabilizers useful in the inventive composition include UV absorbers, singlet oxygen scavengers, antioxidants, and or mixtures, for example, Tinuvin® 292, Tinuvin® 405, Chimas sorb® 20202, Tinuvin® 328, or combinations thereof, all from Ciba® Specialty Chemicals.

Suitable rheology modifiers include polymeric urea urethanes and modified ureas, for example, BYK® 410 and BYK® 411 from BYK-Chemie®.

Dispersants suitable for the inventive compositions include acrylic acid-acrylamide polymers, salts of amine functional compounds and acids, hydroxyl functional carboxylic acid esters with pigment affinity groups, and combinations thereof, for example DISPERBYK®-180, DISPERBYK®-181, DISPERBYK®-108, all from BYK-Chemie® and TEGO® Dispers 710 from Degussa GmbH.

Other additives can be incorporated into the inventive compositions, including wetting agents such as polyether siloxane copolymers, for example, TEGO® Wet 270 and non-ionic organic surfactants, for example TEGO® Wet 500, and combinations thereof; and including deaerators and defoamers such as organic modified polysiloxanes, for example, TEGO® Airex 900.

In some embodiments, photoluminescent compositions components can be from about 10%-50% of binder resin, about 15%-50% of liquid carrier, 2%-35% photoluminescent phosphorescent material, 0.5%-5.0% dispersing agent, 0.2%-3.0% rheology modifying agent, 0.1%-3.0% photostabilizer, 0.2%-2.0% de-aerating agent, 0.2%-3.0% wetting agent, and 0.1%-2.0% photoluminescent fluorescent material.

Methods to prepare photoluminescent objects using the present inventive compositions and which emit either wholly or partially in the visible or infrared can encompass a variety of techniques for application of the photoluminescent compositions described above either onto or into objects. For example, techniques where the compositions described above can be applied onto objects include coating onto the object. Such coating methods for applying photoluminescent compositions onto objects can include but are not limited to screen printing, painting, spraying, dip coating, slot coating, roller coating, and bar coating. Other techniques where the compositions described herein can be applied include printing onto the object. Such printing methods for applying photoluminescent compositions onto objects can include but are not be limited to lithographic printing, ink jet printing, gravure printing, imaged silk screen printing and laser printing as well as manually painting or scribing the object with the photoluminescent compositions described above. In some embodiments, the composition is coated and dried so that the resulting layer is physically robust. The objects selected may additionally have applied to them a second composition which contains one or more of the fluorescent materials described herein. This second applied composition can also serve as a protective coating for the first photoluminescent application.

Photoluminescent objects that make use of the compositions disclosed herein and which emit either wholly or partially in the infrared or visible domain can also be prepared by incorporating the compositions described herein into the objects by including the photoluminescent composition in the manufacture of the object. For example, for plastic objects that can be prepared by extrusion, any of the compositions described above can be added to the object's composition and extruded to give an object which can be identified or detected. In some embodiments, the compositions are incorporated in a range from about 2% to about 30% of the total composition. Preparation of photoluminescent objects wherein the compositions are included in the manufacture of the object can include a variety of manufacturing techniques such as molding, extrusion, etc. For purposes of identification, detection and authentication, an object need only be partially coated with the photoluminescent composition.

Thus, while the “object” disclosed herein for conveying the compositions and related products may be referred to as “preformed,” or as an “object” this is not to be construed as limiting of the teachings herein. That is, the object may be later formed (such as when “off-the-shelf” markings are applied to an item of manufacture) concurrently formed, etc, . . . .

The above described photoluminescent compositions or objects can be charged or activated with electromagnetic radiation, for example, ultraviolet, near ultraviolet or combinations thereof, by a number of convenient methods including metal halide lamps, fluorescent lamps, or any light source containing a sufficient amount of the appropriate visible radiation, UV radiation or both, as well as sunlight, either directly or diffusely, including such times when sunlight is seemingly blocked by clouds. At those times sufficient radiation is present to charge or activate the composition or object. The source of activation can be removed and the object will continue to emit radiation in the selected region and be detected, for example, in darkness when there is no activating radiation.

Since the object will continue to emit the desired radiation, charging of the object and detection of the emission signature can be spatially and temporally decoupled. That is, detection can occur at a time and place separate from activation of the marking. This allows an object either to be charged and removed from the site of activation or to be charged with subsequent removal of the charging source. Further, detection can occur at a distance from the object and/or the activating source.

For the purpose of identification or authentication, a detector that will detect the selected emission signature from the photoluminescent object containing the inventive composition is used. Such detectors may or may not have capability of amplifying the photoluminescent emissions. An example of a detection apparatus with amplification is night vision apparatus. Night vision apparatus can detect either visible radiation if present, infrared radiation, or both visible and infrared radiation. The detection apparatus can be designed to detect specific emission signatures. Where necessary, detectors can incorporate amplification capabilities. Either the detector can be designed to read a specific wavelength of the emission signature, or the composition can be created to emit radiation suitable for a specific detector. Because of the nature of the compositions and markings disclosed herein, detection can occur at a time and place separate from activation.

Under certain conditions, detection equipment may be adversely impacted by radiation from extraneous sources causing identification or detection of the intended object to be difficult due to the inability of the detector to differentiate between emission signature and such spurious radiation. Under these conditions, the detection equipment, for example, night vision apparatus, may be fitted with at least one filter designed to eliminate wavelengths of extraneous radiation thereby enhancing identification or detection.

The type of image obtained from the selected emission signature can be in the form of an amorphous object or it can have informational properties in the form of alphabetical, numerical, or alpha-numeric markings as well as symbols, such as geometric shapes and designations. In this manner identification or detection can be topical, either with up-to-date information, such as times and dates, as well as messages.

Identification or detection methods are inclusive of both those methods, wherein the photoluminescent materials, applied either onto or into an object, to create photoluminescent markings which enable the emission signature, may be detectable by a human observer, and those methods wherein such emissions from such photoluminescent markings are stealth to enable “clandestine” or “stealth” detection. When practicing stealth identification, for the case wherein the emission is only partially in the infrared region of the electromagnetic spectrum, the visible emission component is low enough to be undetectable by a human observer. Identification or detection of the stealth markings described above, either on, or in objects, can only be made by using devices designed to detect the selected emission signature.

Identification or detection methods using the current inventive composition and embodying clandestine detection can be deployed for detection or identification of objects, people or animals. Photoluminescent objects onto or into which such photoluminescent markings can be applied include, for example, military objects to designate friend or foe, as well as trail markings. Such markings are designed to be detected only by selected personnel. Examples of the use of markings for stealth detection include airplane or helicopter landing areas, or markings that reveal the presence or absence of friendly forces.

Identification or detection methods using the current inventive composition and embodying both clandestine and non-clandestine markings allow for identification of, for example, stationary combat apparatus, mobile combat apparatus, combat articles of clothing, or combat gear either worn by combatants or carried by combatants, tanks, stationary artillery, mobile artillery, personnel carriers, helicopters, airplanes, ships, submarines, rifles, rocket launchers, semi-automatic weapons, automatic weapons, mines, diving equipment, diving clothing, knap-sacks, helmets, protective gear, parachutes, and water bottles.

Identification or detection methods using the current inventive composition and embodying both stealth and non-stealth markings allow for identification of, for example, stationary combat apparatus, mobile combat apparatus, combat article of clothing, or combat gear either worn by combatants or carried by combatants, tank, stationary artillery, mobile artillery, personnel carriers, helicopters, airplanes, ships, submarines, rifles, rocket launchers, semi-automatic weapons, automatic weapons, mines, projectiles, diving equipment, diving clothing, knap-sacks, helmets, protective gear, parachutes, water bottles and the like.

The current compositions allow for markings embodying adhesive layers that can not only provide identification or detection but also up-to-date information, such as, for example, times and dates, messages, and military unit identification, thereby rendering renewable or updatable markings.

The current compositions allow for identification or detection including tracking of transportation vehicles, for example, buses, airplanes, taxi cabs, subway vehicles, automobiles and motorcycles.

Identification or detection methods using the current inventive composition and embodying either stealth or non-stealth markings can also be used for applications in sports and entertainment, for example, in hunting and fishing applications which are designed to identify or detect other hunters or fisherman. Stealth markings can be particularly useful in hunting applications wherein accidents can be avoided by using infrared emission detection apparatus for identifying or detecting other hunters but at the same time since no visible emission is detectable, avoiding spooking the hunted animal.

Identification or detection compositions that embody stealth markings may be particularly useful for applications requiring security.

The compositions of the current invention can also be used in anti-counterfeit applications applicable to a wide variety of goods or objects. Photoluminescent objects prepared according to the methods described above can be utilized in anti-counterfeit applications, for example, currency, anti-piracy applications, such as CDs or DVDs, luxury goods, sporting goods etc. In many of these applications it becomes important that the potential counterfeiter be unaware that the object that is being counterfeited contains a marking that will authenticate the object. The clandestine marking can also be coded such as a date code or other identifying code that a counterfeited object would not have.

The current compositions can be applied onto carrier materials, such as films, for example, polyester, polycarbonate, polyethylene, polypropylene, polystyrene, rubber or polyvinyl chloride films, or metallic plates, for example, aluminum, copper, zinc, brass, silver, gold, tin, lead or bronze plates. Other layers can be added to the carrier material such as an adherent material, for example, an adhesive with high or low peel strength or a magnetic material. The carrier material with the photoluminescent material applied thereon can either be attached permanently to an object or it can be transferable so that identification or detection can be changed, updated or removed. Such application allows for an object to have the identification or detection capabilities of the current invention without the object itself undergoing a coating process. In this application, if information becomes outdated, the carrier material with the photoluminescent material applied thereon in the form of a removable film or plate can be replaced by another carrier material with the photoluminescent material applied thereon with updated information, for example, in safety applications or security applications.

In short, the marking disclosed herein can be associated with any desired object in a variety of ways. Whether by attaching, incorporation (such as during fabrication) or by some other techniques as may be known in the art or later devised, it may be considered that associating the marking with the object can be described as “mounting” the marking onto the object, and that making the association may include providing a “mount” (some form of association). Use or application of the marking may be accomplished on a variety of types of products (e.g., commercial, industrial, military, etc, . . . ) and is generally only limited by an ability of an individual to place the marking in an appropriate location, and a user to make use of the marking in a desired way. The marking may be fabricated in a variety of ways. For example, the marking can be incorporated into the object during manufacture. The marking may be built up on the object (such as by coating, printing, spraying etc, . . . ). The marking may be later affixed to the object, such as when applied with an adhesive or otherwise mounted or attached to the object.

An illustration of a method using the teachings herein wherein the photoluminescent object can be created by a photoluminescent transferable film or plate is now described. A suitable carrier sheet, such as, for example, polyethylene terephthalate can be first coated with a release layer, such as, for example, a silicone release layer. A composition can then be applied that includes one or more fluorescent materials. This layer may also serve as a protective layer. A layer of a photoluminescent composition comprising either phosphorescent materials or phosphorescent and fluorescent materials such as those described above is applied, followed by a reflective layer and an adhesive layer. A coversheet which has release characteristics is then applied. In usage the cover sheet is peeled away and the adhesive layer is applied to an object to be identified or detected. The carrier layer that further includes a release layer is removed and a photoluminescent object is obtained.

The current compositions allow for creation of photoluminescent objects wherein at least some of the photoluminescent fluorescent materials are incorporated in a second photoluminescent layer either above or below a first photoluminescent layer, such first photoluminescent layer comprising photoluminescent phosphorescent materials or photoluminescent phosphorescent and photoluminescent fluorescent materials with the net emission from the object being either wholly or partially in the infrared and/or visible domain. It should be noted that such second photoluminescent layers can also serve as a protective coating for the first photoluminescent layer.

Objects prepared using the teachings herein can have low emission intensity by virtue of inadequate reflection of the emitted electromagnetic radiation; either because of surface roughness or because of materials in the object that are absorptive of the selected emission signature. As a result, reflective layers or coatings that are reflective of the emissions from the photoluminescent compositions can be used as primers to provide a surface from which the emission signature can reflect. Hence, a reflective layer may be first applied either onto a carrier material or onto the object itself followed by one or more photoluminescent layers.

Further, certain usages of these objects in which adverse environmental conditions are present require protection, for example, protection from wet conditions, resistance to mechanical abrasion, and improved robustness. In these applications use of a protective layer can be highly beneficial. A protective top-coat can be applied to the objects that have been prepared by the inventive method. Additionally the protective top-coat can be applied to objects that have a reflective coating as described above. Such protective top coats may also include some or all of the photoluminescent fluorescent materials.

### EXAMPLES

### Example 1

Single Layer Embodiment

Into 54.47 g of ethylene glycol monobutyl ether was admixed 20.35 g of NeoCryl® B-818 (an acrylic resin from DSM NeoResins®) To the admix was added 1.80 g of DisperBYK® 180 (from BYK-Chemie), 0.88 g of TEGO® Wet 270 and 0.57 g of TEGO.RTM. Airex 900 (both from Degussa GmbH) with stifling. Then 0.10 g of rhodamine 19P, 0.10 g of dichlorofluorescein, 0.10 g of Nile Blue, 0.10 g of Nile Red, 0.05 g of sulfarhodamine B, 0.01 g of rhodamine 800 and 0.01 g of 3,3′-diethyloxatricarbocyanine iodide were added and mixed until dissolved. 20.35 g of H-13, green phosphor (from Capricorn Specialty Chemicals) was then added. Following this, 1.11 g of BYK® 410 was then added. The photoluminescent composition thus prepared was coated onto a 3″×8″ swatch of white Mylar® film using a wire draw down bar, and dried at 50° C. (<5% solvent) for 12 hours to a dried thickness of 10 mils. The coated Mylar® swatch was placed in a RPS 900 emission spectrometer. An emission signature of 720 nm was measured. The coated Mylar® and an uncoated Mylar® swatch were placed 1 foot from a 150 watt metal halide lamp and exposed for 15 minutes.

After one hour the swatches were removed to a light-locked room and observed using a Generation 3 proprietary night vision monocular scope from a distance of 5 feet. The coated swatch showed a bright, vivid image while the uncoated swatch was undetectable. The swatches were monitored hourly without further exposure to electromagnetic radiation. After 13 hours the coated swatch continued to persist in emitting radiation that was detectable by the night scope.

### Example 2

Two Layer Embodiment

First Layer Composition

Into 17.80 g ethylene glycol monomethyl ether, 13.35 g butyl acetate, 8.90 g ethylene glycol monobutyl ether and 4.45 g ethyl alcohol was admixed 37.92 g of NeoCryl® B-818 (an acrylic resin from DSM NeoResins®). To the admix was added 0.28 g of Tinuvin® 405 (from Ciba Specialty Chemicals), 2.46 g of DisperBYK® 180 (from BYK-Chemie), 1.19 g of TEGO® Wet 270 and 0.78 g of TEGO® Airex 900 (both from Degussa GmbH). Then 0.06 g of rhodamine 19P, 0.03 g of Nile Blue, 0.06 g of Nile Red, 0.06 g of dichlorofluorescein, 0.03 g sulfarhodamine B, 0.01 g of rhodamine 800 and 0.01 g of 3,3′-diethyloxatricarbocyanine iodide were added and mixed until dissolved. Subsequently, 11.1 g of H-13, green phosphor (from Capricorn Specialty Chemicals) and 1.51 g of BYK 410 (from BYK-Chemie) were then added.

Second Layer Composition

Into 61.99 g of ethylene glycol monobutyl ether was admixed 34.44 g of NeoCryl® B-818 (an acrylic resin from DSM NeoResins®). To the admix was added 2.00 g of Tinuvin® 405 (from Ciba Specialty Chemicals), 0.34 g of TEGO® Wet 270 and 1.03 g of TEGO® Airex 900 (both from Degussa GmbH). Subsequently, 0.20 g of rhodamine 110 was added to the admix and then mixed until dissolved.

Two Layer Construction

The first layer composition was applied onto a 3″×8″ swatch of white Mylar® film using a wire draw down bar, and dried at 50° C. (<5% solvent) for 12 hours to a dried thickness of 10 mils. The second layer composition was then applied onto the first layer using a wire draw down bar and dried at 50° C. (<5% solvent) for 12 hours to a dried thickness of 1 mil.

The two-layered swatch was placed in a RPS 900 emission spectrometer. An emission signature of 730 nm was measured. The swatch was placed 1 foot from a 150 watt metal halide lamp and exposed for 15 minutes. The swatch was then taken to a light-locked room where there was no emission observable with the unaided eye even after the eyes adjusted to the dark for 15 minutes. Using a Generation 3 proprietary night vision monocular scope from a distance of 5 feet, the swatch showed a bright, vivid image. After 13 hours, the swatch continued to persist in emitting radiation that was detectable by the night scope.

### Example 3

The method described in Example 1 was repeated using a polystyrene placard in place of the Mylar® and with the alphanumeric “Danger !!!” written thereon. The placard was placed outside, affixed to a tree at approximately noon. Under nighttime conditions the placard could not be seen. When observed through a pair of night vision, IR sensitive goggles the alphanumeric was prominently displayed and the alphanumeric could be noted.

In short, it has been found that photoluminescent compositions and products as disclosed herein permit detection and identification of objects when these materials are associated with or applied to the objects. The compositions and products may include photoluminescent phosphorescent materials, photoluminescent fluorescent materials and combinations thereof. A key advantage of the use of the photoluminescent phosphorescent materials is that they can be activated or excited without requiring specialized sources. That is, for example, the materials can be charged with naturally-occurring illumination for most of the day, and then provide users with robust emissions needed for remote detection and identification. Further, with the use of high luminous intensity and persistent photoluminescent compositions, such as those described herein, object identification or detection at daytime or nighttime can be practiced at great distances from the object and/or its activation source and long after activation has ceased. The materials and compositions can also be stimulated by other forms of energy, thus providing additional or enhanced output.

Having thus described aspects of the invention, one skilled in the art will recognize that a variety of compositions and arrangements of compositions may be useful for practice of the teachings herein. Accordingly, the compositions and arrangements of compositions disclosed herein are merely illustrative of embodiments, and are not limiting of the invention disclosed herein.

Further, a variety of objects may be aided by the teachings herein. That is, while various consumer goods, industrial goods, military goods and the like have been introduced as suited for marking or identification with the materials disclosed herein, it should be recognized that the only limitations as to what may be a suitable object include practical limitations (such as surface area afforded to retention of the marking) and other such limitations as a user may encounter. Accordingly, while it is considered that a broad range of objects are suited to conveyance of the markings disclosed herein, it is considered that any object capable of presenting the marking is within the scope of the teachings herein.

Therefore, while the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of fabricating a marking for object, the method comprising:
selecting a plurality of photoluminescent materials for incorporation into a composition by correlating emission wavelengths exhibited by one of the materials with absorbance wavelengths of another one of the materials for each of the plurality, thus providing for a cascade of wavelengths from an excitation wavelength to an output wavelength for the marking upon completion of fabrication;
incorporating the plurality of materials into the marking; and
adapting the marking for association with the object.

2. The method as in claim 1, wherein providing comprises selecting the materials to provide an output wavelength that is substantially in the ultraviolet domain of the electromagnetic spectrum.

3. The method as in claim 1, wherein providing comprises selecting the materials to provide an output wavelength that is substantially in the visible domain of the electromagnetic spectrum.

4. The method as in claim 1, wherein providing comprises selecting the materials to provide an output wavelength that is substantially in the infrared domain of the electromagnetic spectrum.

5. The method as in claim 1, wherein selecting comprises selecting materials that comprise at least one phosphorescent material.

6. The method as in claim 1, wherein selecting comprises selecting materials that comprise at least one fluorescent material.

7. The method as in claim 1, wherein incorporating comprises applying a layer to the marking.

8. The method as in claim 1, wherein selecting further comprises choosing at least one of the materials according to at least one of an excitation wavelength, an output wavelength, and characteristics of an emission signature.

9. The method as in claim 1, further comprising designing the marking to blend with surroundings.

10. The method as in claim 1, wherein the plurality of photoluminescent materials comprises at least one high persistence phosphor.

11. The method as in claim 1, wherein at least one of the photoluminescent materials comprises one of metal sulfide and metal aluminate.

12. The method as in claim 1, further comprising incorporating at least one material that exhibits a property that is at least one of thermochromic, electrochromic, solvatochromic, halochromic, ionochromic, tribochromic and piezochromic.

13. A method of marking an object, the method comprising:
selecting a marking that comprises a composition that comprises an effective amount of a plurality of photoluminescent materials, the materials comprising at least one phosphorescent material and, at least one fluorescent material;
wherein each of the photoluminescent materials in the composition absorbs electromagnetic radiation of a first wavelength and emit electromagnetic radiation of a second wavelength; and wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking; and
applying the marking to the object.

14. The method as in claim 13, wherein the selecting comprises selecting an object that is one of a commercial, an industrial, and a military type of object.

15. The method as in claim 13, wherein applying comprises at least one of incorporating the marking into the object during manufacture, building the marking on the object, and later affixing the marking to the object.

16. The method as in claim 13, wherein the selecting comprises selecting an object that is one of a projectile, a vehicle, a textile, and for undersea deployment.

17. A method for identifying an object, the method comprising:
gazing at an detection area, and when a potential emission signature is detected;
comparing the potential emission signature with a known emission signature, the known emission signature being associated with a marking that comprises a composition that comprises an effective amount of a plurality of photoluminescent materials;
wherein each of the photoluminescent materials in the composition absorbs electromagnetic radiation of a first wavelength and emit electromagnetic radiation of a second wavelength;
wherein the materials have been selected so that emission of a first one of the materials correlates with absorbance of another one of the materials in the plurality thus providing for a cascade of wavelengths beginning with a wavelength of electromagnetic radiation used for charging the marking to an output wavelength of the marking.

18. The method as in claim 17, wherein the materials comprise at least one phosphorescent material.

19. The method as in claim 17, wherein the materials comprise at least one fluorescent material.

20. The method as in claim 17, wherein the selection of materials comprises choosing at least one of the materials according to at least one of an excitation wavelength, an output wavelength, and characteristics of an emission signature.

21. The method as in claim 17, further comprising detecting the potential emission signature with at least one of an optical sensor exhibiting a sensitivity to the output wavelength, a charge-coupled device (CCD) and a complementary metal oxide semiconductor (CMOS) device.

22. The method as in claim 17, wherein comparing comprises evaluating at least one of wavelengths and intensity associated with a primary emission and any secondary emissions of the marking.

23. The method as in claim 17, wherein gazing comprises monitoring the detection area for wavelengths that are at least one of ultraviolet, visible and infrared.

24. The method as in claim 17, further comprising exciting the marking on the object with wavelengths that are at least one of ultraviolet, visible and infrared.

25. The method as in claim 17, further comprising exciting the marking on the object with wavelengths from at least one of a natural source and an artificial source.

26. The method as in claim 25, wherein the artificial source comprises at least one of a metal halide source, a strobe, a fluorescent lamp, combustion of an incendiary device and combustion of a combustible material.

27. A marking for an object, the marking comprising:
a composition that comprises an effective amount of a plurality of photoluminescent materials, the materials comprising
at least one phosphorescent material and,
least one fluorescent material;
wherein each of the photoluminescent materials in the composition absorbs electromagnetic radiation of a first wavelength and emit electromagnetic radiation of a second wavelength;
wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking; and
a mount for associating the marking with the object.

28. The marking as in claim 27, further comprising a material that exhibits a property that is at least one of thermochromic, electrochromic, solvatochromic, halochromic, ionochromic, tribochromic and piezochromic.

29. A method of tracking an object, the method comprising:
selecting an object comprising a marking, the marking comprising a plurality of photoluminescent materials; wherein each of the photoluminescent materials in the composition absorbs electromagnetic radiation of a first wavelength and emit electromagnetic radiation of a second wavelength; and wherein the materials have been selected so that emission of a first one of the materials correlates with absorbance of another one of the materials in the plurality, thus providing for a cascade of wavelengths beginning with a wavelength of electromagnetic radiation used for charging the marking to an output wavelength of the marking;
energizing the marking; and
observing the object.

30. The method as in claim 29, wherein the output wavelength is in at least one of the infrared and the visible domain.

31. The method as in claim 29, wherein the photoluminescent materials comprise at least one of a phosphorescent material and a fluorescent material.

32. The method as in claim 29, wherein the marking further comprises a material that exhibits at least one of a thermochromic, electrochromic, solvatochromic, halochromic, ionochromic, tribochromic and piezochromic property.

33. The method as in claim 29, wherein the energizing comprises at least one of illuminating the marking with an excitation source, and stimulating the marking with a source that provides at least one of a thermochromic, electrochromic, solvatochromic, halochromic, ionochromic, tribochromic and piezochromic stimulation.

34. The method as in claim 29, wherein the object comprises a projectile.
